(19) United States
(12) Patent Application Publication
(10) Pub. No.: US 2016/0192400 A1
(43) Pub. Date: Jun. 30, 2016

(54) METHOD FOR TRANSMITTING AND RECEIVING RANDOM ACCESS CHANNEL SIGNAL IN WIRELESS COMMUNICATION SYSTEM

(71) Applicant: Electronics and Telecommunications Research Institute, Daejeon (KR)

(72) Inventors: Kyung Yeol SOHN, Daejeon (KR); Youn Ok PARK, Daejeon (KR)

(21) Appl. No.: 14/949,168

(22) Filed: Nov. 23, 2015

(30) Foreign Application Priority Data
Dec. 30, 2014 (KR) 10-2014-0194274
Aug. 24, 2015 (KR) 10-2015-0118735

(51) Int. Cl. H04W 74/08; H04W 24/08

(52) U.S. Cl. CPC H04W 74/0833; H04W 24/08

(57) ABSTRACT

Provided is a method of transmitting and receiving a signal in a wireless communication. The method of transmitting and receiving a signal in a wireless communication includes: transmitting a transmission beam to a terminal in an area which exists within a preset cluster; receiving a random access channel signal including a random access code mapped to the cluster; and detecting the random access code by using the random access channel signal.

### CROSS-REFERENCE TO RELATED APPLICATION

This application claims the benefit of priority to Korean Patent Application No. 10-2014-0194274, filed on Dec. 30, 2014 in the Korean Intellectual Property Office, and Korean Patent Application No. 10-2015-0118735, filed on Aug. 24, 2015 in the Korean Intellectual Property Office, the disclosure of which is incorporated herein in its entirety by reference.

### BACKGROUND OF THE INVENTION

1. Field of the Invention

The present invention relates to a method for transmitting and receiving a random access channel signal in a wireless communication system, and more particularly, to a method and an apparatus for transmitting and receiving a cluster-based random access channel signal in a wireless communication system using a multi-beam.

2. Description of the Related Art

In order to meet the ever-increasing demand for wireless data traffic, various methods for improving a data transmission rate in a wireless communication system have been proposed. A method to increase the bandwidth of the signal may be considered as one of those various methods. In this case, since it is difficult to secure a broad frequency band in a bandwidth of 10 GHz or less used in a general wireless communication system, it is expected to use a cellular communications technology using a millimeter wave (mmWave) band that can increase frequency efficiency while securing an idle bandwidth.

When performing cellular communication through a mmWave band, it is possible to obtain a broad bandwidth and it can be considered to use space resource as well as time, frequency, and code resource through beam forming based on a propagation characteristic of linearity, so that radio capacity may be increased significantly. However, as a high frequency is used, a pathloss and a poor penetration characteristic may occur. Accordingly, there is a problem in that a service area is reduced.

In order to solve this problem, a cellular communication using a mmWave band adopts a method of operating a plurality of beams based on a beamforming technology that can concentrate the service area of the radio wave in a specific direction using a plurality of antennas.

A wireless communication system using a multi-beam is configured in such a manner that a base station and a plurality of terminals share the same frequency band and the same time slot based on a multi beam technology and transmit and receive signals. The plurality of terminals that receive the same beam may be allocated orthogonal components which are divided in a time or frequency domain to communicate with the base station. At this time, the transmission beam (uplink) used in the terminal may have a wide radiation pattern in comparison with a precise transmission beam used in the base station due to physical space limitation, performance limitation, cost limitation, and the like. Accordingly, when the terminal exists in a location in which the transmission and reception beams of the base station are superimposed, the possibility of interference between the signals transmitted to the uplink is increased.

In particular, when the terminal is initially connected to the base station or accomplishes handover, there may be a problem in that the time spent in a random access (RA) may be increased due to the interference between the signals transmitted to the uplink.

In addition, when a reflector exists around the terminal while an accurate beam is not formed between the base station and the terminal, the uplink signal of a non line-of-sight (NLOS) environment may be transmitted with a greater intensity due to the synthesis of adjacent beams rather than the beam of a line-of-sight (LOS) environment which the terminal transmits to the base station.

### SUMMARY OF THE INVENTION

The present invention has been made in view of the above problems, and provides a method for transmitting and receiving a random access channel signal which can tie the transmission and reception beams of a base station and the random access codes which a terminal transmits to the base station in pairs of cluster and process signals in a cluster unit in a wireless communication environment using a multi-beam.

The present invention further provides a method for transmitting and receiving a random access channel signal which can reduce interference transmitted from a terminal which does not belong to a cluster, thereby minimizing a delay time generated in a process of detecting a random access code from a random access channel signal by a base station.

The present invention further provides a method for transmitting and receiving a random access channel signal which can enhance a probability of random access code detection by efficiently combing signals distributed by a reflector existing around a terminal.

In accordance with an aspect of the present invention, a method of transmitting and receiving a signal in a wireless communication includes: transmitting a transmission beam to a terminal in an area which exists within a preset cluster, receiving a random access channel signal including a random access code mapped to the cluster, and detecting the random access code by using the random access channel signal.

A plurality of the random access code are mapped to the cluster. The transmission beam includes information on a beam ID identifying the transmitted beam, the beam ID and the random access code are mapped, and the beam ID is transmitted through a synchronization signal or a reference signal of the transmission beam. The beam which is transmitted to the terminal is able to be divided in a cluster unit, and a plurality of transmission beams are able to be transmitted into the cluster. Information on the cluster is shared between a base station and the terminal or is transmitted from the base station to the terminal through a system message. The method of transmitting and receiving a signal in a wireless communication further includes: measuring a strength of the random access channel signal, and comparing the strength of the random access channel signal with a certain threshold value to implement a signal diversity. The signal diversity is implemented through a maximum ratio combining (MRC) or an equal gain combining (EGC).

In accordance with another aspect of the present invention, a method of transmitting and receiving a signal in a wireless communication includes: detecting a beam ID of a transmission beam having the strongest signal strength among received transmission beams of a base station, selecting a random access code mapped to a certain cluster corresponding to the beam ID; and transmitting a random access channel signal including the random access code to a base station.

According to an embodiment of the present invention, provided is the method for transmitting and receiving a random access channel signal which can tie the transmission and reception beams of a base station and the random access codes which a terminal transmits to the base station in pairs of cluster and process signals in a cluster unit in a wireless communication environment using a multi-beam.

In addition, the method for transmitting and receiving a random access channel signal may reduce interference transmitted from a terminal which does not belong to a cluster, thereby minimizing a delay time generated in a process of detecting a random access code from a random access channel signal by a base station.

In addition, according to an embodiment of the present invention, provided is the method for transmitting and receiving a random access channel signal which can enhance a probability of random access code detection by efficiently combing signals distributed by a reflector existing around a terminal.

### BRIEF DESCRIPTION OF THE DRAWINGS

The objects, features and advantages of the present invention will be more apparent from the following detailed description in conjunction with the accompanying drawings, in which:

FIG. 1 is a diagram illustrating a configuration of a base station using a multi-beam and a terminal according to an embodiment of the present invention;

FIG. 2 is a diagram illustrating an example of configuring a sector by using a combination of an elevation angle and an azimuth of a transmission beam transmitted from a base station according to an embodiment of the present invention;

FIG. 3 is a diagram illustrating a terminal that transmits signals to a base station in an area in which the transmission and reception beams of base station are superimposed;

FIG. 4 is a diagram illustrating a random access signal which is transmitted from a terminal and which is reflected by a reflector around the terminal to be transmitted to a base station; and

FIG. 5 is a flowchart illustrating a method for transmitting and receiving a random access channel signal by a base station according to an embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

Prior to a detailed description of the present invention, terms and words used in the specification and the claims shall not be interpreted as commonly-used dictionary meanings, but shall be interpreted as to be relevant to the technical scope of the invention based on the fact that the inventor may property define the concept of the terms to explain the invention in best ways. Therefore, the embodiments and the configurations depicted in the drawings are illustrative purposes only and do not represent all technical scopes of the embodiments, so it should be understood that various equivalents and modifications may exist at the time of filing this application. Some constituent elements shown in the drawings may be exaggerated, omitted or schematically drawn for the purpose of convenience or clarity.

In a mmWave band, a base station is possible to generate and operate a multi-beam having a plurality of thin and precise beam by using a beamforming technology, and to assign an identifier (ID) for each of the generated beam. Beam identifier information may be transmitted by using a synchronization signal or may be transmitted by using a reference signal which is different from the synchronization signal.

For example, in a 3GPP LTE system, the synchronization signal may be a primary synchronization signal (PSS) or a secondary synchronization signal (SSS), and the reference signal may be a pilot signal which known transmission location of both the base station and the terminal. At this time, the base station may be provided at a location of a certain height, and the beam has a preset beam width. The beam width of a beam generated in the base station may be defined for an elevation angle and azimuth respectively.

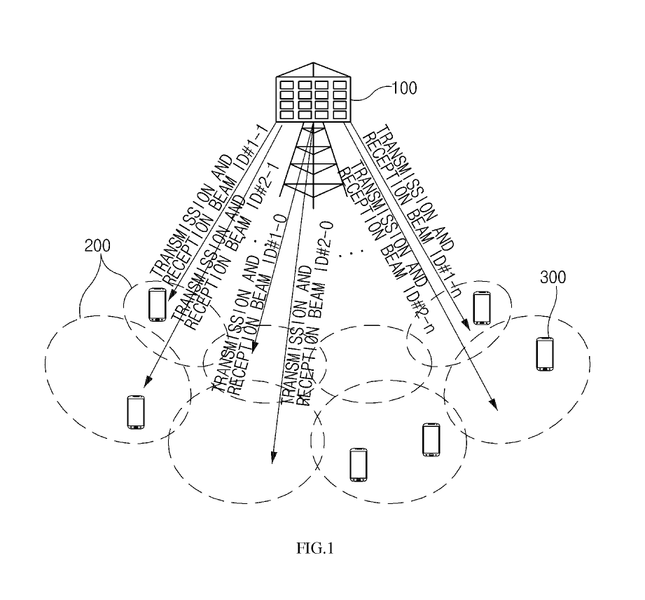

FIG. 1 is a diagram illustrating a configuration of a base station using a multi-beam and a terminal according to an embodiment of the present invention.

A base station 100 may generate a multi-beam to transmit to a terminal 300. As shown, the beam has a certain beam width, and may be transmitted to the terminal 300 existing in different areas 200 depending on the beam width and a direction of transmission.

When the base station 100 transmits data using the multi-beam, in order to determine a transmission beam to be transmitted to the terminal 300, the terminal 300 should identify the transmission and reception beam area 200 of the base station 100 in which the terminal 300 is located.

At this time, the multi-beam used in the base station 100, that is, the transmission and reception beam may have a beam width which is previously determined by the elevation angle and azimuth, and thus, each area 200 processed by the transmission and reception beam may be determined.

As described above, the beam transmitted to each area 200 may have a unique ID individually (e.g., #1-1, #2-1).

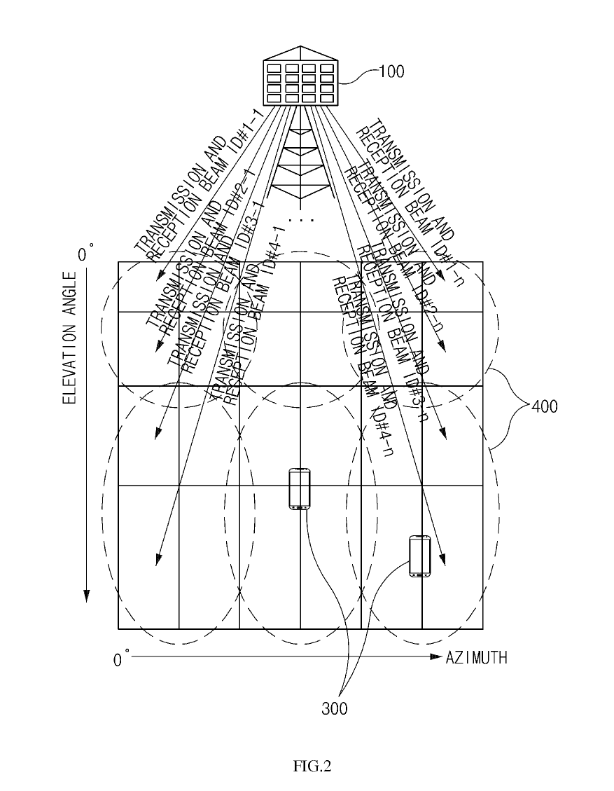

FIG. 2 is a diagram illustrating an example of configuring a sector by using a combination of an elevation angle and an azimuth of a transmission beam transmitted from a base station according to an embodiment of the present invention.

The processing area of the beam transmitted and received in the base station 100 may be previously determined, and the beam may be transmitted with a unique transmission and reception beam ID.

By using this, a plurality of transmission and reception beams may be classified by a cluster 400 unit which can tie the beams together to process. As shown in FIG. 2, the beams having beam ID #1-1, #2-1 may be classified as a single cluster 400 and processed, and the beams having beam ID #3-1, #4-1 may be classified as a single cluster 400 and processed.

That is, the base station 100 may tie one or more multi-beams in a cluster unit in order to process the multi-beams in a specific unit, and may enhance a diversity effect by combining control signals transmitted from the terminal 300 within an arbitrary cluster 400. At this time, one or more multi-beams of the transmission and reception beam transmitted from the base station may be divided in the cluster unit (A, B, . . . , N) depending on an environment of the area which the transmission and reception beam of the base station can cover, and information on the cluster may be shared between the base station and the terminal or may be transmitted from the base station to the terminal through a system message.

The following [Table 1] represents a division of random access codes which are available in the base station according to an embodiment of the present invention corresponding to the transmission and reception beam cluster.

TABLE 1

| | Random access code set available in |
|---|---|
| Cluster | terminal |
| a | 1~A |
| b | A + 1~A + B |
| . . . | . . . |
| n | (A + B + . . .) + 1~(A + B + . . .) + N |

As shown in [Table 1], cluster a may be assigned random access codes of number A having a range from 1 to A, cluster b may be assigned random access codes of number B having a range from A+1 to A+B, and cluster n may be assigned random access codes of number N having a range from (A+B+ . . . )+1 to (A+B+ . . . )+N. Preferably, one or more random access codes, mapped to one cluster, are allocated in order to avoid a conflict.

The number of the random access codes included in each cluster may be the same (A=B= . . . =N), or may have different values (A B . . . N) depending on a range of the area which the transmission and reception beam of the base station covers.

In addition, the base station may allocate one or more random access codes for each transmission reception beam ID in order to distinguish the beams belonging to the cluster of the transmission reception beam. The allocated random access code may minimize the conflict in the random access process between the terminals that receive a beam having the same ID by applying a cyclic shift method, such as a cyclic shift that is applied to the Zadoff-Chu sequence of a LTE/LTE-Adv System.

Meanwhile, when the base station uses a cluster as shown in [Table 1] and a corresponding random access code, a random access code belonging to one cluster is mapped not to be used in another cluster so that a random access channel signal for the random access code included in the cluster (b, c, . . . , n) excluding a base station cluster (a) may not be detected in the reception beam of the base station cluster (a). That is, when the transmission beam ID is identified, the cluster to which the terminal belongs can be identified, and thus, a random access code set to be used in the terminal may be formed. In addition, in the base station, when the random access code transmitted by the terminal is identified, a specific beam area of a specific cluster to which the terminal belongs can be identified. In this case, the random access channel signal for a code excluding [Table 1] may use a random access code having a good correlation property with the random access code in [Table 1]. For example, the Zadoff-Chu sequence, and the like used in the LTE/LTE-Adv and the WiBro/WiBro-Adv system may be used.

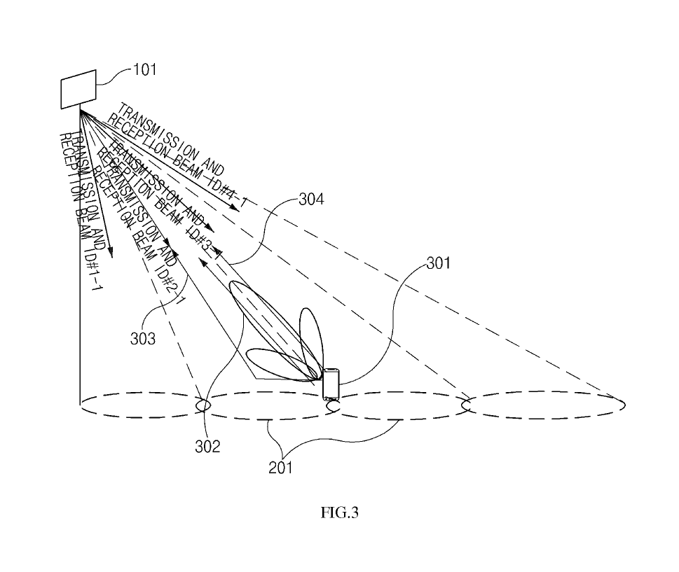

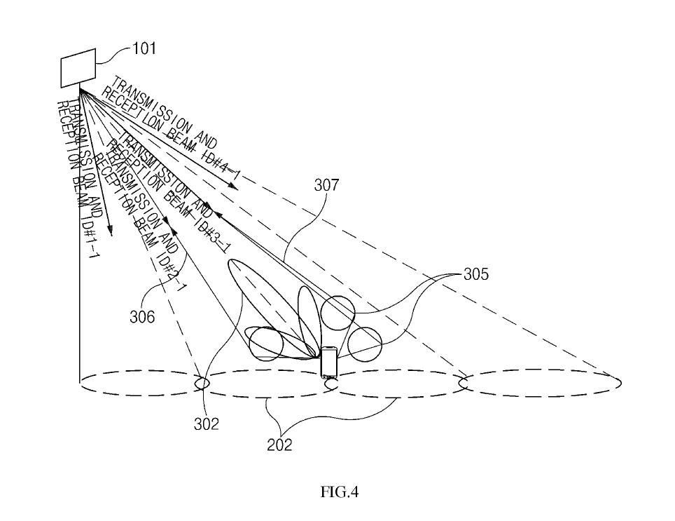

FIG. 3 is a diagram illustrating a terminal that transmits signals to a base station in an area in which the transmission and reception beams of base station are superimposed, and FIG. 4 is a diagram illustrating a random access signal which is transmitted from a terminal and which is reflected by a reflector around the terminal to be transmitted to a base station.

As shown in FIG. 3, when a plurality of beams are formed in the base station 101, the transmission beam may have a fan shape when there is no obstacle, and may be transmitted while being spread. In this case, when multiple beams are transmitted by the base station 101, a superposition 201 may occur in an area which the beams cover.

When the terminal 301 exists in the area 201 in which the beams are superimposed, undesired signal interference may occur when the terminal 301 transmits a signal in response to the received beam to the base station 101.

For example, the terminal 301 may generate a response signal by using a random access code mapped to a specific cluster which is selected based on the transmission beam ID of a transmission beam having the strongest signal strength among the beams received from the area in which the transmission beams of the base station are superimposed. As shown, even when the response signals 302 and 304 are transmitted by using the random access code which is mapped to the specific cluster, the signal 304 may be transmitted to an adjacent reception beam undesirably, and, in this case, interference may occur due to a undesired signal.

In addition, as shown in FIG. 4, the terminal may be located in the area in which the line-of-sight (LOS) environment and the non-line-of sight (NLOS) area coexist. In this case, when a reflector 305 such as a building or a mountain exists around the terminal while an accurate beam is not formed between the base station and the terminal, at least one of the reflected signals 306 and 307 may have a relatively stronger signal strength than the signal 302 transmitted to the base station directly from the terminal and may be transmitted to the base station as a signal of the adjacent beam.

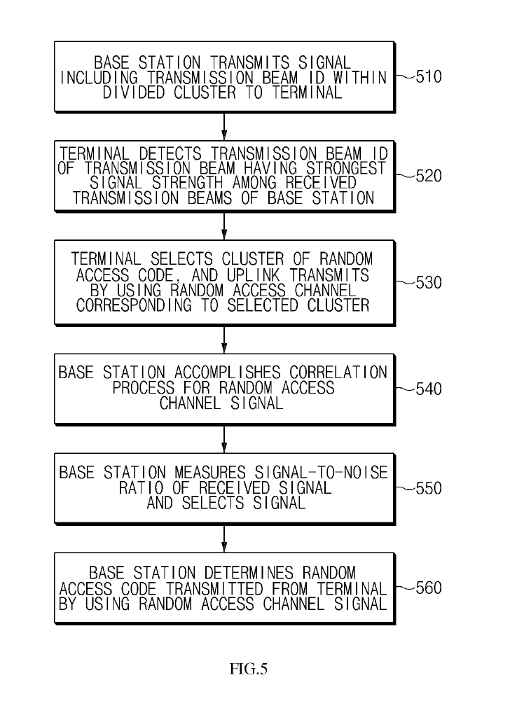

FIG. 5 is a flowchart illustrating a method for transmitting and receiving a random access channel signal by a base station according to an embodiment of the present invention.

First, the base station may transmit a signal including the transmission beam ID within the divided cluster to the terminal (510).

In this case, information on the division of the cluster may be previously shared between the base station and the terminal or the base station may transmit information on a specific cluster to be used to the terminal through a system message. Obviously, since a mapping relation is established between the transmission beam ID and the clusters, the cluster may be identified by only the transmission beam ID.

In addition, as described above, since the random access channel code is mapped according to a specific cluster, the system message which the base station transmits to the terminal may include the random access channel code, and the terminal may identify the random access code corresponding to the beam which is transmitted to the terminal through the system message.

The terminal may detect the transmission beam ID of the transmission beam having the strongest signal strength among the received transmission beams of the base station (520).

The terminal that detected the transmission beam ID of the transmission beam having the strongest signal strength may select the cluster of the random access code which is one-to-one mapped to the cluster including the detected transmission beam ID of the base station, and may accomplish an uplink transmission by using the random access channel corresponding to a relevant cluster (530).

The base station may accomplish a correlation process for the random access channel signal with respect to the uplink which is received by using the random access code which is one-to-one mapped to the transmission beam which the base station transmitted (540).

In addition, the base station may measure the signal-to-noise ratio of the signal output from each reception beam, and compare the measured signal-to-noise ratio with an arbitrary threshold value which determines the existence of the signal to perform a process of selecting a signal (550).

The base station may perform the Maximum Ratio Combining (MRC) for obtaining a diversity effect or the Equal Gain Combining (EGC) with respect to the reception beam signal within the cluster exceeding an arbitrary threshold value in the process of selecting a signal and distinguishing the selected signal from a noise.

In the mobile communication, a diversity technique is used as a measure for a fading caused by a multi-path. The multi-path means that multiple transmission signals are received by a receiving antenna through various paths in the air. When the multiple signals are received through different paths, different amplitude attenuation and phase shift may be accomplished. When these signals are merged at the time of receiving, the signal strength may vary differently from the transmission signal according to a change of time, which is referred to as fading. The diversity technique may overcome the fading by receiving and properly combining a number of signals that are affected by an independent fading.

The method for synthesizing respective signals that are affected by the fading from the diversity branch may include the above-described maximum ratio combining method, the equal gain combining method, and a selection synthesis method.

The maximum ratio combining method is a method of combining signals in the best ratio, the equal gain combining method is a method of combining signals in the same phase, and the selection synthesis method is a method of comparing all signals received from different branches at any given and selecting the best signal.

Then, the base station may determine the random access code transmitted from the terminal by using a combined random access channel signal (560). Through this, it is possible to minimize the interference by the adjacent terminals and to reduce a delay time which occurs in the process of detecting the random access code.

As described above, the present invention relates to the method for transmitting and receiving a cluster based random access channel signal in a wireless communication environment using a multi-beam, and is able to reduce interference transmitted from a terminal which does not belong to a cluster, thereby minimizing a delay time generated in a process of detecting a random access code from a random access channel signal by a base station.

In addition, the present invention provides the method for transmitting and receiving a cluster based random access channel which can enhance a probability of random access code detection by efficiently combing signals distributed by a reflector existing around a terminal.

In the above description, it should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of transmitting and receiving a signal in a wireless communication, the method comprising:
transmitting a transmission beam to a terminal in an area which exists within a preset cluster;
receiving a random access channel signal including a random access code mapped to the cluster; and
detecting the random access code by using the random access channel signal.

2. The method of claim 1, wherein a plurality of the random access code are mapped to the cluster.

3. The method of claim 1, wherein the transmission beam includes information on a beam ID identifying the transmitted beam, the beam ID and the random access code are mapped, and the beam ID is transmitted through a synchronization signal or a reference signal of the transmission beam.

4. The method of claim 1, wherein the transmission beam which is transmitted to the terminal is divided in a cluster unit, and a plurality of transmission beams are transmitted into the cluster.

5. The method of claim 1, wherein information on the cluster is shared between a base station and the terminal or is transmitted from the base station to the terminal through a system message.

6. The method of claim 1, further comprising:
measuring a strength of the random access channel signal; and
comparing the strength of the random access channel signal with a threshold value to implement a signal diversity.

7. The method of claim 6, wherein the signal diversity is implemented through a maximum ratio combining (MRC) or an equal gain combining (EGC).

8. A method of transmitting and receiving a signal in a wireless communication, the method comprising:
detecting a beam ID of a transmission beam having the strongest signal strength among received transmission beams of a base station;
selecting a random access code mapped to a cluster corresponding to the beam ID; and
transmitting a random access channel signal including the selected random access code to a base station.

9. The method of claim 8, wherein a plurality of the random access code are mapped to the cluster.

10. The method of claim 8, wherein the beam ID and the random access code are mapped.

11. The method of claim 8, wherein the beam ID is transmitted through a synchronization signal or a reference signal of the transmission beam.
